(19) United States
(12) Patent Application Publication
(10) Pub. No.: US 2012/0124858 A1
(43) Pub. Date: May 24, 2012

(54) TUMBLE TYPE DRYING DEVICE HAVING PARTIAL THERMAL FLOW RETURNING STRUCTURE

(76) Inventor: Tai-Her YANG, Dzan-Hwa (TW)

(21) Appl. No.: 12/952,347

(22) Filed: Nov. 23, 2010

(51) Int. Cl. F26B 11/02

(52) U.S. Cl. 34/524

(57) ABSTRACT

The present invention relates to a tumble type drying device having partial thermal flow returning structure, in which a return flowpath structure for introducing a partial thermal flow discharged from a tumble is installed at an air inlet flowpath of the tumble type drying device; with the installation of a novel distribution structure for thermal flow returning and discharging, the partial returned thermal flow and the air flow introduced from the air inlet flowpath are enabled to be preheated and mixed for saving energy.

### BACKGROUND OF THE INVENTION

(a) Field of the Invention

The present invention relates to a tumble type drying device having partial thermal flow returning structure, in which a return flowpath structure for introducing a partial thermal flow discharged from a tumble is installed at an air inlet flowpath of the tumble type drying device; with the installation of a novel distribution structure for thermal flow returning and discharging, the partial returned thermal flow and the air flow introduced from the air inlet flowpath are enabled to be preheated and mixed for saving energy.

(b) Description of the Prior Art

A conventional rolling type drying device, e.g. a tumble type drying device, utilizes an electric fluid pump set for pumping the inlet air flow to pass through an electric heating device so as to be heated then introduced into a tumble chamber; the thermal air flow is then discharged to the exterior after the clothes are dried. During the operation, the means for discharging the thermal air flow is a direct discharging means, which may cause unnecessary waste of thermal and electric energy.

### SUMMARY OF THE INVENTION

The present invention aims at a tumble type cloth drying device, wherein an electric fluid pump is installed for pumping air flow so the room temperature air flow introduced from an air inlet and an air inlet flowpath is heated through electric and thermal energy to transform to a thermal flow for drying the clothes rolling in a tumble then the thermal flow is discharged to the exterior, to be further installed with a distribution structure for thermal flow returning and discharging that enables the room temperature air flow from an air inlet flowpath and the thermal flow output from the tumble to be introduced therein and be mixed, and a part of the mixed air flow is discharged from an air discharge outlet, while a major part of the mixed air flow passes through an air inlet of an electric heating device for being heated then introduced into the interior of the tumble, and the room temperature air flow from the air inlet flowpath can be mixed and preheated through introducing the thermal energy of the partial discharged thermal air flow, so as to reduce the thermal energy loss and save the electric energy required by electric heating.

### BRIEF DESCRIPTION OF THE DRAWINGS

FIG. 1 is a schematic view showing the main structure according to one embodiment of the present invention.

FIG. 2 is a schematic structural view showing the outlet of a mixed and preheated fluid outlet (1024) being installed with a static flow regulating structure (1207), according to one embodiment of the present invention.

FIG. 3 is a schematic structural view showing the outlet of the mixed and preheated fluid outlet (1024) being installed with a free rotation stirring blade structure (1028), according to one embodiment of the present invention.

### DESCRIPTION OF MAIN COMPONENT SYMBOLS

101: Air inlet
102: Distribution structure for thermal flow returning and discharging
1021: Room temperature air flow introducing port
1022: Returned thermal flow introducing port
1023: Cold/hot flow mixing and preheating space structure
1024: Mixed and preheated fluid outlet
1025: Thermal flow shunting device
1026: Shunted thermal flow outlet
1027: Static flow regulating structure
1028: Free rotational stirring blade structure
103: Electric heating device
104: Tumble
105: Tumble driving motor set
106: Electric fluid pump set
1061: Fan motor
1062: Fan
107: Electric control device
108: External operation interface
109: Air outlet
110: Air inlet flowpath

### DETAILED DESCRIPTION OF THE PREFERRED EMBODIMENTS

A conventional rolling type drying device, e.g. a tumble type drying device, utilizes an electric fluid pump set for pumping the inlet air flow to pass through an electric heating device so as to be heated then introduced into a tumble chamber; the thermal air flow is then discharged to the exterior after the clothes are dried. During the operation, the means for discharging the thermal air flow is a direct discharging means, which may cause unnecessary waste of thermal and electric energy.

The present invention relates to a tumble type drying device having partial thermal flow returning structure, in which a return flowpath structure for introducing a partial thermal flow discharged from a tumble is installed at an air inlet flowpath of the tumble type drying device; with the installation of a novel distribution structure for thermal flow returning and discharging, the partial returned thermal flow and the air flow introduced from the air inlet flowpath are enabled to be preheated and mixed for saving energy.

The present invention aims at a tumble type cloth drying device, wherein an electric fluid pump is installed for pumping air flow so the room temperature air flow introduced from an air inlet and an air inlet flowpath is heated through electric and thermal energy to transform to a thermal flow for drying the clothes rolling in a tumble then the thermal flow is discharged to the exterior, to be further installed with a distribution structure for thermal flow returning and discharging that enables the room temperature air flow from an air inlet flowpath and the thermal flow output from the tumble to be introduced therein and be mixed, and a part of the mixed air flow is discharged from an air discharge outlet, while a major part of the mixed air flow passes through an air inlet of an electric heating device for being heated then introduced into the interior of the tumble, and the room temperature air flow from the air inlet flowpath can be mixed and preheated through introducing the thermal energy of the partial discharged thermal air flow, so as to reduce the thermal energy loss and save the electric energy required by electric heating.

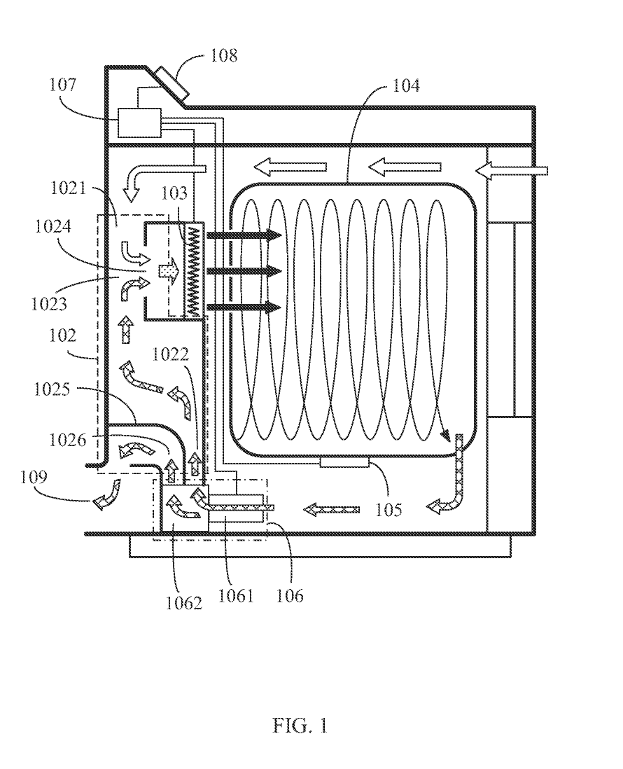

FIG. 1 is a schematic view showing the main structure according to one embodiment of the present invention.

As shown in FIG. 1, except for being installed with a case, a power cable and a tumble device driven by an electric motor, it mainly consists of:

Air inlet (101): with the pumping operation performed by an electric fluid pump set (106), the air inlet (101) allows the external room temperature air flow to be introduced, and the thermal flow heated by an electric heating device (103) is discharged through a tumble (104), a part of the thermal flow passes through a distribution structure for thermal flow returning and discharging (102) for being mixed and preheated with the room temperature air flow introduced from the air inlet (101) and an air inlet flowpath (110) so as to raise the temperature, then the mixed air flow is heated by the electric heating device (103) then introduced into the tumble (104), while a part of the thermal flow from the tumble (104) is discharged to the exterior through an air outlet (109);

Distribution structure for thermal flow returning and discharging (102): equipped with a room temperature air flow introducing port (1021) for introducing the external room temperature air flow, a returned thermal flow introducing port (1022) for introducing the thermal flow discharged by the tumble (104), a cold/hot flow mixing and preheating space structure (1023) for the room temperature air flow and the partial returned thermal flow, a mixed and preheated fluid outlet (1024), and a thermal flow shunting device (1025) for shunting the thermal flow from the tumble (104) into two parts, wherein a part of the thermal flow is served to flow towards the returned thermal flow introducing port (1022), the other part of the thermal flow is served to flow towards a shunted thermal flow outlet (1026), the shunt ratio of the two parts is set by the thermal flow shunting device (1025) for being fixed and flexible, and the other part of the thermal flow from the tumble (104) is shunted by the thermal flow shunting device (1025) and passed through the shunted thermal flow outlet (1026) then discharged to the exterior through the air outlet (109);

Electric heating device (103): constituted by an electric heating device in which heating being operated through electric energy, controlled by an electric control device (107) to perform operations of controlling the heating temperature and operations of ON or OFF, and provided for reheating the mixed and preheated fluid from the mixed and preheated fluid outlet (1024) of the distribution structure for thermal flow returning and discharging (102) for transforming to a high-temperature thermal flow;

Tumble (104): driven by a tumble driving motor set (105) constituted by a tumble driving motor and a transmission device, to perform operations at a set rotational speed and direction, the tumble (104) has a thermal flow inlet and outlet, the interior of the tumble (104) is provided for placing clothes or articles to be dried, and the tumble (104) is driven by the tumble driving motor set (105) to perform rotations for receiving the thermal flow used for drying clothes;

Tumble driving motor set (105): in which the electric motor is controlled by the electric control device (107), and through the transmission device to drive the tumble (104) to rotate at a set rotational speed and direction;

Electric fluid pump set (106): in which the flowing kinetic energy of the fluid is generated through a fan motor (1061) being powered so as to drive a fan (1062), for enabling the external room temperature air flow to pass through the electric heating device (103) for being heated then introduced into the tumble (104), and allowing the partial thermal flow discharged from the tumble (104) to be pumped, wherein a part of the thermal flow is shunted by the thermal flow shunting device (1025) to pass through the returned thermal air flow introducing port (1022) for entering the cold/hot flow mixing and preheating space structure (1023) of the distribution structure for thermal flow returning and discharging (102), so as to be mixed and preheated with the room temperature air flow introduced from the air inlet (101) and the air inlet flowpath (110), then to be heated by the electric heating device (103) and introduced into the tumble (104);

and a part of the thermal flow from the tumble (104) is shunted by the thermal flow shunting device (1025) to pass through the shunted thermal flow outlet (1026) and to be discharged to the exterior from the air outlet (109);

Electric control device (107): constituted by the electromechanical components, or solid state electronic components, and/or microprocessors and operation software for receiving the electric energy from a power supply and receiving the setting and operation by an external operation interface (108) thereby control the operations of the electric heating device (103), the tumble driving motor set (105) and the electric fluid pump set (106);

External operation interface (108): constituted by the electromechanical components, or solid state electronic components, and/or microprocessors and operation software for receiving manual input to control the operation of the electric control device (107);

Air outlet (109): provided for discharging the shunted thermal flow of the shunted thermal flow outlet (1026) of the distribution structure for thermal flow returning and discharging (102) to the exterior;

with the mentioned device, when a user wants to actuate the operation through the external operation interface (108), the electric control device (107) actuates the electric fluid pump set (106), the electric heating device (103) and the tumble driving motor set (105); meanwhile the room temperature air flow passes through the air inlet (101) and enters the air inlet flowpath of the distribution structure for thermal flow returning and discharging (102), and is initially heated by the electric heating device (103) then is introduced into the tumble (104), and a part of the thermal flow discharged by the tumble (104) returns to the distribution structure for thermal flow returning and discharging (102) so as to be mixed and preheated with the room temperature air flow which is subsequently introduced for a purpose of raising temperature, the heated air flow passes through the electric heating device (103) from the mixed and preheated fluid outlet (1024) of the distribution structure for thermal flow returning and discharging (102) for being further heated so as to be transformed to high-temperature thermal flow, then reenters the interior of the tumble (104) driven by the tumble driving motor set (105) for drying clothes, then the thermal flow is discharged from the air outlet of the tumble (104) and enters the inlet of the thermal flow flowpath of the distribution structure for thermal flow returning and discharging (102), wherein a part of the thermal flow is again mixed with the room temperature air flow from the air inlet (101), and another part of the thermal flow passes through the thermal flow flowpath of the distribution structure for thermal flow returning and discharging (102) and discharged from the air outlet (109) thereby discharge the moisture at in the meantime.

According to the present invention of the tumble type drying device having partial thermal flow returning structure, for homogeneously mixing the room temperature air flow introduced from the room temperature air flow introducing port (1021) and the partial thermal flow from the returned thermal flow introducing port (1022), following improvements are further provided:

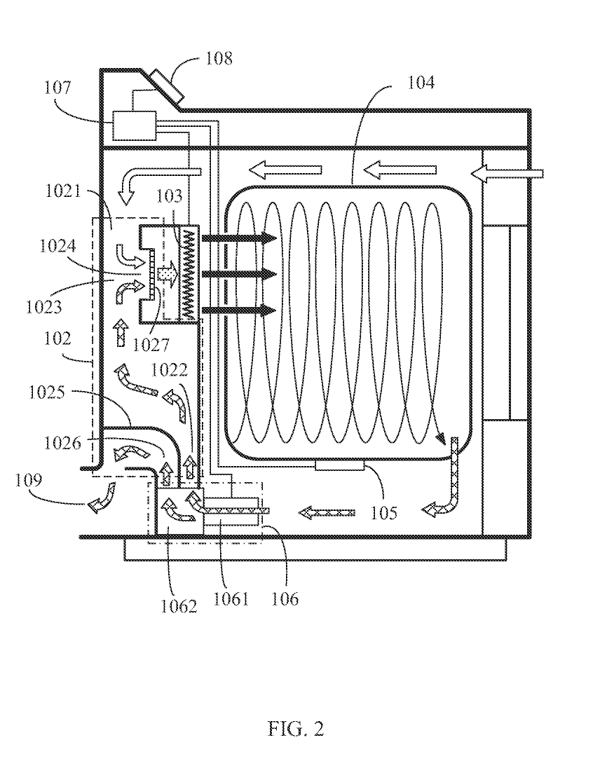

FIG. 2 is a schematic structural view showing the outlet of a mixed and preheated fluid outlet (1024) being installed with a static flow regulating structure (1027), according to one embodiment of the present invention.

As shown in FIG. 2, in the tumble type drying device having partial thermal flow returning structure, a static flow regulating structure (1027) is installed between the mixed and preheated fluid outlet (1024) and the electric heating device (103), and the static flow regulating structure (1027) is configured to a maze type mixing functional structure, or multiple grids type mixing functional structure, or multiple partitions type mixing functional structure, so the mixed and preheated air flow can be homogenized so as to be provided to the electric heating device (103) for reheating.

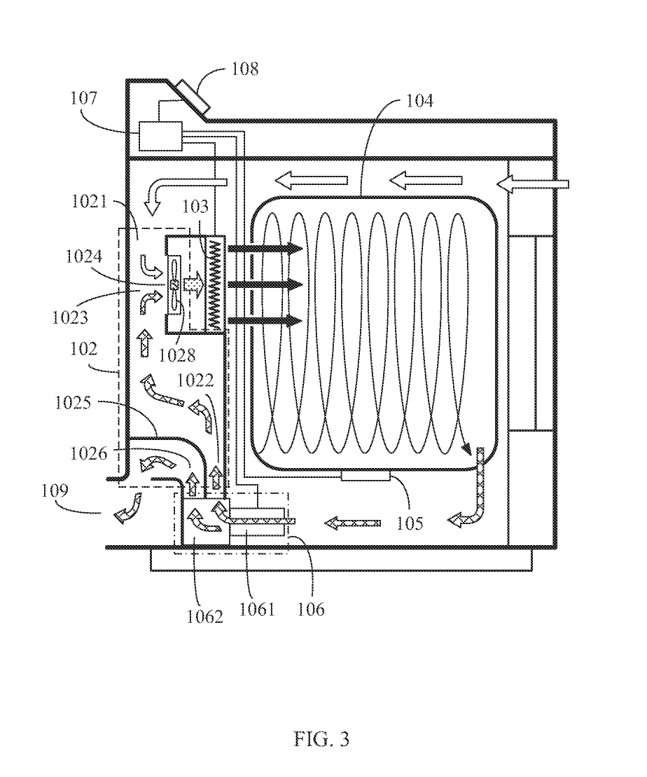

FIG. 3 is a schematic structural view showing the outlet of the mixed and preheated fluid outlet (1024) being installed with a free rotational stirring blade structure (1028), according to one embodiment of the present invention.

As shown in FIG. 3, in the tumble type drying device having partial thermal flow returning structure, a free rotational stirring blade structure (1028) is installed between the mixed and preheated fluid outlet (1024) and the electric heating device (103), with the free rotation of the free rotational stirring blade structure (1028), the mixed and preheated air flow can be stirred for being homogenized so as to be provided to the electric heating device (103) for reheating.

According to the present invention, the static flow regulating structure (1027) and the free rotational stirring blade structure (1028) respectively shown in FIG. 2 and FIG. 3 can both be installed between the mixed and preheated fluid outlet (1024) and the electric heating device (103).

1. A tumble type drying device having partial thermal flow returning structure, in which a return flowpath structure for introducing a partial thermal flow discharged from a tumble being installed at an air inlet flowpath of the tumble type drying device; with the installation of a novel distribution structure for thermal flow returning and discharging, the partial returned thermal flow and the air flow introduced from the air inlet flowpath being enabled to be preheated and mixed for saving energy, and except for being installed with a case, a power cable and a tumble device driven by an electric motor, it mainly consists of:
Air inlet (101): with the pumping operation performed by an electric fluid pump set (106), the air inlet (101) allows the external room temperature air flow to be introduced, and the thermal flow heated by an electric heating device (103) is discharged through a tumble (104), a part of the thermal flow passes through a distribution structure for thermal flow returning and discharging (102) for being mixed and preheated with the room temperature air flow introduced from the air inlet (101) and an air inlet flowpath (110) so as to raise the temperature, then the mixed air flow is heated by the electric heating device (103) then introduced into the tumble (104), while a part of the thermal flow from the tumble (104) is discharged to the exterior through an air outlet (109);
Distribution structure for thermal flow returning and discharging (102): equipped with a room temperature air flow introducing port (1021) for introducing the external room temperature air flow, a returned thermal flow introducing port (1022) for introducing the thermal flow discharged by the tumble (104), a cold/hot flow mixing and preheating space structure (1023) for the room temperature air flow and the partial returned thermal flow, a mixed and preheated fluid outlet (1024), and a thermal flow shunting device (1025) for shunting the thermal flow from the tumble (104) into two parts, wherein a part of the thermal flow is served to flow towards the returned thermal flow introducing port (1022), the other part of the thermal flow is served to flow towards a shunted thermal flow outlet (1026), the shunt ratio of the two parts is set by the thermal flow shunting device (1025) for being fixed and flexible, and the other part of the thermal flow from the tumble (104) is shunted by the thermal flow shunting device (1025) and passed through the shunted thermal flow outlet (1026) then discharged to the exterior through the air outlet (109);
Electric heating device (103): constituted by an electric heating device in which heating being operated through electric energy, controlled by an electric control device (107) to perform operations of controlling the heating temperature and operations of ON or OFF, and provided for reheating the mixed and preheated fluid from the mixed and preheated fluid outlet (1024) of the distribution structure for thermal flow returning and discharging (102) for transforming to a high-temperature thermal flow;
Tumble (104): driven by a tumble driving motor set (105) constituted by a tumble driving motor and a transmission device, to perform operations at a set rotational speed and direction, the tumble (104) has a thermal flow inlet and outlet, the interior of the tumble (104) is provided for placing clothes or articles to be dried, and the tumble (104) is driven by the tumble driving motor set (105) to perform rotations for receiving the thermal flow used for drying clothes;
Tumble driving motor set (105): in which the electric motor is controlled by the electric control device (107), and through the transmission device to drive the tumble (104) to rotate at a set rotational speed and direction;
Electric fluid pump set (106): in which the flowing kinetic energy of the fluid is generated through a fan motor (1061) being powered so as to drive a fan (1062), for enabling the external room temperature air flow to pass through the electric heating device (103) for being heated then introduced into the tumble (104), and allowing the partial thermal flow discharged from the tumble (104) to be pumped, wherein a part of the thermal flow is shunted by the thermal flow shunting device (1025) to pass through the returned thermal air flow introducing port (1022) for entering the cold/hot flow mixing and preheating space structure (1023) of the distribution structure for thermal flow returning and discharging (102), so as to be mixed and preheated with the room temperature air flow introduced from the air inlet (101) and the air inlet flowpath (110), then to be heated by the electric heating device (103) and introduced into the tumble (104);
and a part of the thermal flow from the tumble (104) is shunted by the thermal flow shunting device (1025) to pass through the shunted thermal flow outlet (1026) and to be discharged to the exterior from the air outlet (109);
Electric control device (107): constituted by the electromechanical components, or solid state electronic components, and/or microprocessors and operation software for receiving the electric energy from a power supply and receiving the setting and operation by an external operation interface (108) thereby control the operations of the electric heating device (103), the tumble driving motor set (105) and the electric fluid pump set (106);
External operation interface (108): constituted by the electromechanical components, or solid state electronic components, and/or microprocessors and operation software for receiving manual input to control the operation of the electric control device (107);
Air outlet (109): provided for discharging the shunted thermal flow of the shunted thermal flow outlet (1026) of the distribution structure for thermal flow returning and discharging (102) to the exterior;
with the mentioned device, when a user wants to actuate the operation through the external operation interface (108), the electric control device (107) actuates the electric fluid pump set (106), the electric heating device (103) and the tumble driving motor set (105); meanwhile the room temperature air flow passes through the air inlet (101) and enters the air inlet flowpath of the distribution structure for thermal flow returning and discharging (102), and is initially heated by the electric heating device (103) then is introduced into the tumble (104), and a part of the thermal flow discharged by the tumble (104) returns to the distribution structure for thermal flow returning and discharging (102) so as to be mixed and preheated with the room temperature air flow which is subsequently introduced for a purpose of raising temperature, the heated air flow passes through the electric heating device (103) from the mixed and preheated fluid outlet (1024) of the distribution structure for thermal flow returning and discharging (102) for being further heated so as to be transformed to high-temperature thermal flow, then reenters the interior of the tumble (104) driven by the tumble driving motor set (105) for drying clothes, then the thermal flow is discharged from the air outlet of the tumble (104) and enters the inlet of the thermal flow flowpath of the distribution structure for thermal flow returning and discharging (102), wherein a part of the thermal flow is again mixed with the room temperature air flow from the air inlet (101), and another part of the thermal flow passes through the thermal flow flowpath of the distribution structure for thermal flow returning and discharging (102) and discharged from the air outlet (109) thereby discharge the moisture at in the meantime.

2. The tumble type drying device having partial thermal flow returning structure as claimed in claim 1, wherein it is further installed with a static flow regulating structure (1027) between the mixed and preheated fluid outlet (1024) and the electric heating device (103), and the static flow regulating structure (1027) is configured to a maze type mixing functional structure, or multiple grids type mixing functional structure, or multiple partitions type mixing functional structure, so the mixed and preheated air flow can be homogenized so as to be provided to the electric heating device (103) for reheating.

3. The tumble type drying device having partial thermal flow returning structure as claimed in claim 1, wherein it is further installed with a free rotational stirring blade structure (1028) between the mixed and preheated fluid outlet (1024) and the electric heating device (103), with the free rotation of the free rotational stirring blade structure (1028), the mixed and preheated air flow can be stirred for being homogenized so as to be provided to the electric heating device (103) for reheating.

4. The tumble type drying device having partial thermal flow returning structure as claimed in claim 1, wherein the static flow regulating structure (1027) and the free rotational stirring blade structure (1028) are both installed between the mixed and preheated fluid outlet (1024) and the electric heating device (103).
